(19) United States
(12) Patent Application Publication
(10) Pub. No.: US 2016/0057213 A1
(43) Pub. Date: Feb. 25, 2016

(54) COUPLING APPLICATION DATA WITH NETWORK CONNECTIVITY

(71) Applicants: Gary S. GREENBAUM, (US); Rahul AGARWAL, (US)

(72) Inventors: Gary S GREENBAUM, Mercer Island, WA (US); Rahul AGARWAL, Bellevue, WA (US)

(21) Appl. No.: 14/781,118

(22) PCT Filed: Mar. 29, 2014
(86) PCT No.: PCT/US14/32290

§ 371 Date: Sep. 29, 2015

Related U.S. Application Data
(60) Provisional application No. 61/806,816, filed on Mar. 29, 2013.

(51) Int. Cl. H04L 29/08

(52) U.S. Cl. CPC H04L 67/1025; H04L 67/101; H04L 67/1012

(57) ABSTRACT

Embodiments of the disclosure are directed towards a system configured to enable network connectivity between a dynamic application and a remote resource server where the network connectivity is coupled to application data on the remote resource server as requested from a dynamic application residing on a device. The system is configured to allow fine-grain coupling of network connectivity whereby permitted subsets of the application data are provisioned for access by the dynamic application. The network connectivity may be selectively coupled to a suite of applications, a specific application, a specific subset of the application data, or the like. The selectively coupling of the network connection being based on at least one access rule in the transitory rule list generated for the dynamic application given a current state.

### RELATED APPLICATIONS

This application claims priority under 35 U.S.C. Section 119(e) to U.S. Provisional Application Ser. No. 61,806,816, filed Mar. 29, 2013 entitled “Coupling Application Data with Network Connectivity,” the disclosure of which is incorporated by reference herein in its entirety.

### BACKGROUND

End-users interface with computing devices through software. The software includes software applications that access data residing on remote network connected servers. These software applications are hereinafter referred to as device applications. The device applications require network connectivity in order to access the data residing on the remote network-connected servers. Prevalent today is the ability to acquire any number of device applications and separately to acquire network access for all software on the computing device. The separately acquired network access then allows all dynamic device applications to request and receive (i.e., access) data stored on the remote servers.

The current network connectivity options require a user to either obtain a data access contract from a network service provider for an allocated amount of data that is shared among all of its device applications or agree to a bundle of services for access to static applications. The present disclosure describes a novel approach for enabling network connectivity between a dynamic application and a remote resource server where the network connectivity is coupled to application data on the remote resource server as requested from the dynamic application residing on a device.

### SUMMARY

Embodiments of the disclosure are directed towards a system configured to enable network connectivity between a dynamic application and a remote resource server where the network connectivity is coupled to application data on the remote resource server as requested from a dynamic application residing on a device. The system is configured to allow fine-grain coupling of network connectivity whereby permitted subsets of the application data are provisioned for access by the dynamic application. The network connectivity may be selectively coupled to a suite of applications, a specific application, a specific subset of the application data, or the like. The selectively coupling of the network connection being based on at least one access rule in the transitory rule list.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a conceptual overview of a system configured to enable network connectivity between a dynamic application and a remote resource server where the network connectivity is coupled to application data on the remote resource server as requested from a dynamic application residing on a device;

FIG. 2 is a system view of functional components for implementing at least one embodiment of the system illustrated in FIG. 1;

FIG. 3 is another system view of another embodiment of the functional components for implementing another embodiment of the system in FIG. 1;

FIG. 4 is yet another system view of another embodiment of the functional components for implementing yet another embodiment of the system in FIG. 1;

FIG. 5 is a flow diagram illustrating a process suitable for use in the functional components illustrated in FIGS. 2-4;

FIG. 6 is a flow diagram of a process for determining a transitory rule list suitable for use in FIG. 5;

FIG. 7 is an exemplary representation of a dynamically defined truncated state graph that is suitable to generate a transitory rule list in accordance with the process illustrated in FIG. 6; and

FIG. 8 is a functional block diagram representing a computing device for use in certain implementations of the disclosed embodiments or other embodiments of the components, such as illustrated in FIGS. 2-4.

### DETAILED DESCRIPTION

The following disclosure describes a novel approach for enabling network connectivity between a dynamic application and a remote resource server where the network connectivity is coupled to application data on the remote resource server as requested from a dynamic application residing on a device. The present system offers several advantages over existing systems, such as not requiring a computing device in the system to acquire connectivity for the device in order to enable resident application access to remote data. Instead, network connectivity can be selectively bound to any specific, dynamic device application. The network connectivity may provide granular network access, such as to one specific application, a specific subset of the data requested in a particular application, a suite of applications, and the like. Another advantage of the present system is that the authorization and enforcement of application content delivery is performed by a remote network access server. For the present disclosure, dynamic applications are applications where the state space, internal or external, may be unbounded, such as when the dynamic application has non-deterministic sources of data located on resource servers not previously associated with the dynamic device application. Examples of dynamic applications having non-deterministic sources of data include search, communications, social apps, and the like. For example, in social networking applications, external resource links may be constantly added.

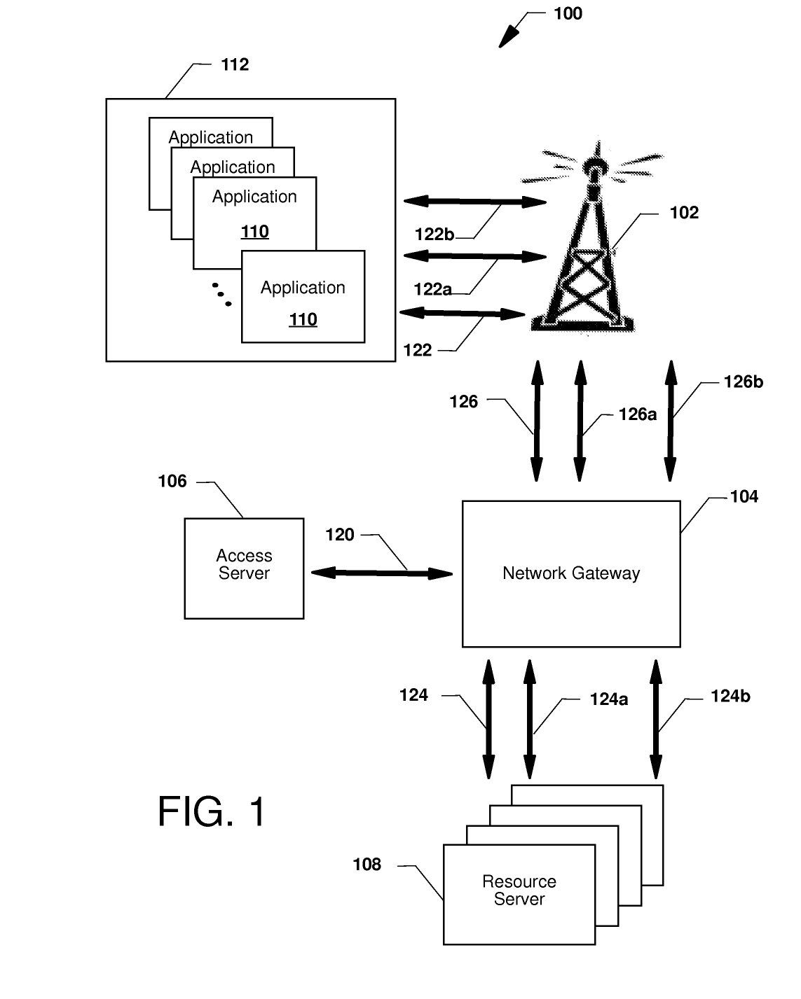

FIG. 1 is a conceptual overview of a system 100 configured to enable network connectivity between a dynamic application and a remote resource server where the network connectivity is coupled to application data on the remote resource server as requested from a dynamic application residing on a device. The system 100 includes a physical network 102, a network gateway 104, an access server 106, one or more resource servers 108, and one or more applications 110. The access server 106 is a server remote from a computing device 112 on which the applications 110 are processed. The network gateway 104 provides common functionality for routing network traffic across heterogeneous networks. The network gateway 104 routes the network traffic coming from and going to computing device 112 via a computing device network 122, a network 126, and a remote resource server network 124. The computing device network 122, the network 126, and the remote resource server network 124 may be heterogeneous networks. For example, computing device network 122 may be a cellular network, a wireless network, a wireless local area network (LAN), and the like. The network configuration uses common configurations known in the art. The network gateway 104 translates incoming network protocols to appropriate outbound network protocols and enforces access policies between device applications 110 and remote resource servers 108. In addition, the network gateway 104 routes data traffic to the access server 106 via an access server network 120, which is another heterogeneous network. In one embodiment, the network gateway 104 may be a business information technology (IT) gateway server that proxies network traffic from a corporate network, i.e. intranet, to the public Internet. In this embodiment, the computing device 112 may be connected via a fixed line network connection, such as Ethernet.

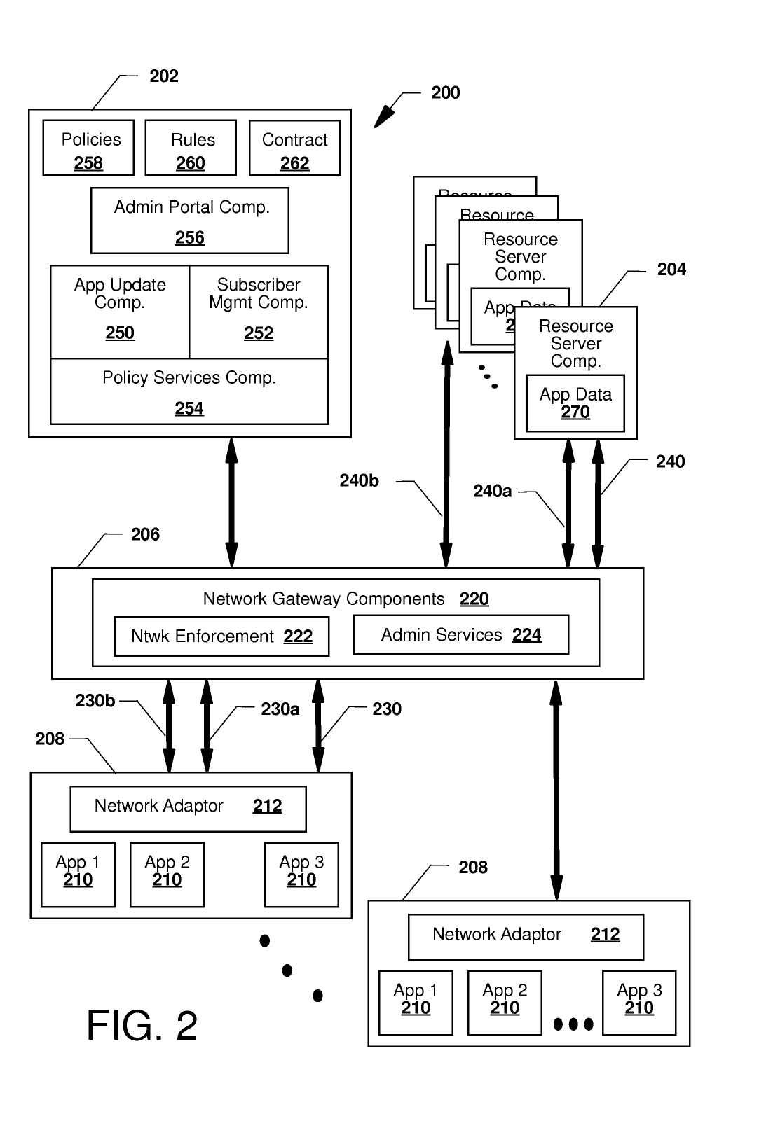

As will be described in FIG. 2, system 100 is configured to enable network connectivity between a dynamic application and a remote resource server where the network connectivity is coupled to application data on the remote resource server as requested from a dynamic application residing on a device. The network connectivity between the dynamic application and the remote resource server is an individual network connection. Thus, each individual device application 110 is associated with an individual network connection providing its network connectivity to permitted application data. In FIG. 1, two individual network connections are illustrated. Networks 122a, 126a, and 124a represents an individual network connection coupled to one of applications 110 and networks 122b, 126b, and 124b represent another individual network connection coupled to another one of applications 110. As one will appreciate, any number of individual network connections may be available to each computing device 112. Each individual network connection may be associated and/or sponsored by a different provider. For example, one network connection may be provided by a sponsor offering a trial offer to its associated application data.

FIG. 2 is a system view of functional components 200 for enabling network connectivity between a dynamic application and a remote resource server where the network connectivity is coupled to application data on the remote resource server as requested from a dynamic application residing on a device in accordance with at least one embodiment of the system shown in FIG. 1. In one implementation, a content provider may restrict access to their content without a data access contract, but allow limited access to one or more specific items of content based on a user's application state. Once the policy is determined by the content provider, the content provider does not need to communicate any changes about their resource servers, because the present system dynamically maintains access to their resource servers based on the policy provided. In addition, the content provider supports an individual network connection between the individual device application and their resource servers so that data traffic between the individual device application and their resource server allows access to the permitted data. Thus, the individual device application is appropriately limited to permitted data and does not have unlimited access to other data on the content provider's resource server or other resource servers via the individual network connection.

The functional components 200 include an access server component 202, one or more resource server components 204, a network operator component 206, and one or more device components 208. Each of the device components 208 include one or more device applications 210 and a network adaptor component 212. The network adaptor component 212 enables the device applications 210 to access application data 270 associated with the resource server components 204 via the network operator component 206. The network operator component 206 performs a multiplicity of roles including device and end-user authentication, billing, data tracking, and enforcing network policies consistent with permissions determined by contracts between the network operator and outside agents. The network operator component 206 includes a network gateway component 220 having a network enforcement component 222 and network administration services component 224. The network gateway component 220 facilitates data exchange between the device application 210 and a resource server component 204 over heterogeneous networks 230 and 240. Networks 230 and 240 each have a state representing the respective network's capability, utility, or the like. The network enforcement component 222 enforces network access policies. The administration services component 224 authenticates device components 208 and validates permissions to access the network operator component 206. The authentication may be at a device level, an application level, a specific content level, an application suite level, or the like. The access server component 202 communicates with the network enforcement component 222.

The access server component 202 includes an app update component 250, a subscriber management component 252, a policy services component 254, and an administration portal component 256. The administration portal component 256 affirms a delivery contract 262. The access server 202 may have multiple delivery contracts, each delivery contract being associated with at least one of the computing devices 208 (shown in FIG. 1) and at least one of the device applications 110 (shown in FIG. 1).

The app update component 250 is configured to continuously monitor device application remote resource server requests and to translate access policies 258 into rules 260 (e.g., a rule list) associated with a device application. The rule list 260 is stateful, which means the rule list specifies which resource servers may be accessed by the device application 210 based on a given state of the device application 210 and the state of the network 240 on which the resource server components 204 reside. Depending on the state of the network, the destination of the requested resource server may be unique to a particular application request. The state of the device application 210 may be determined by data in the request message to the remote resource server, by a sequence of prior requests made by the device application 210, or the like.

The subscriber management component 252 stores application access policies 258 associated with device permissions. The permissions may be determined by an application provider, purchased by a device owner, sponsored by a device manufacturer, or acquired by any other means. In accordance with the present disclosure, permissions may change over time and may depend on prior application requests. The subscriber management component 252 requests the app update component 250 to pass the stateful rule list 260 to the policy services component 254 if the computing device and its associated delivery contracts are validated.

The policy service component 254 is configured to communicate with the network enforcement component 222 within the network operator component 206. The network enforcement component 222 uses the stateful rule list 260 that was communicated to it to determine whether a device application can access application data 270 associated with the requested resource server component 204. In some embodiments of the present system, a multiplicity of applications may be granted access to the application data 270. In other embodiments, all device applications may be granted access to application data residing on multiple resource servers available to the network operator's network gateway. In yet another embodiment, only a specific subset of application data may be granted access from a request from the device application 210.

The administration portal component 256 may be configured as an external interface or portal. The external interface or portal allows designated agents to administer and manage application data request policies, perform real-time data and billing audits, and modify device and subscriber offers. Application data request policies 258 may be defined by outside agents, such as a network operator, application developer, content provider, or the like. The policies 258 describe the access permissions of the device applications 28 to resource server components 204. Access policies 258 may be complex statements that depend on multiple parameters, such as access duration, aggregate data delivery limits, device and end-user content licenses, valid delivery contracts, and the like.

The data exchanged between device applications 210 and the resource server components 204 traverses the network operator component 206 via heterogeneous networks 230 and 240. As was discussed above in conjunction with FIG. 1, components 200 are configured to dynamically provision a subset of data on a requested resource server 204 to be accessible to an individual device application 210 that is coupled to its associated individual network connection. Thus, each individual device application 210 is associated with an individual network connection. In FIG. 2, two individual network connections are represented. For example, networks 230a and 240b represents an individual network connection coupled to one of applications 210 (e.g., App 1) and networks 230b and 240b represent another individual network connection coupled to another one of applications 210 (e.g., App 2). The network traffic data is intercepted by the network gateway component 220 so that incoming network protocols can be translated into appropriate outbound network protocols and routing information. The network enforcement component 222 is configured to enforce the rule list 260 between the device applications 210 and the resource server components 204.

While FIG. 2 and the corresponding description describes the interaction between several components, it can be appreciated that such components can include additional or fewer components or the functionality described for one component can be combined with another component without departing from the claimed invention. Thus, the described functionality of the components can be implemented using various permutations and combinations of components.

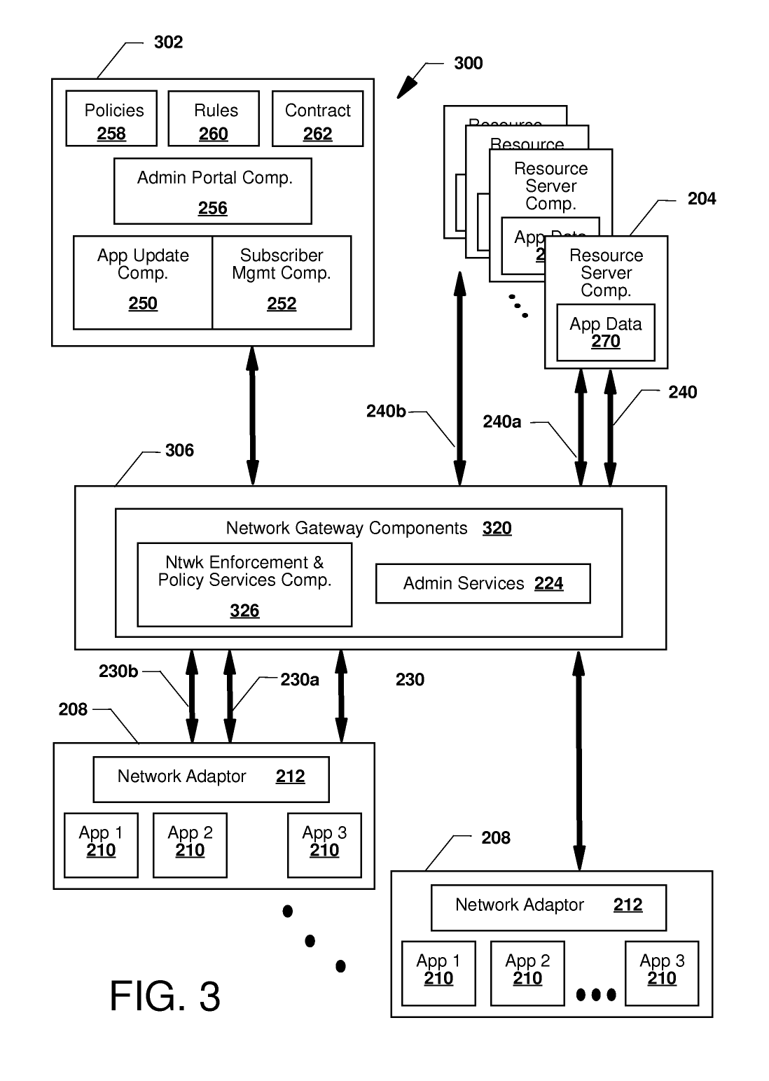

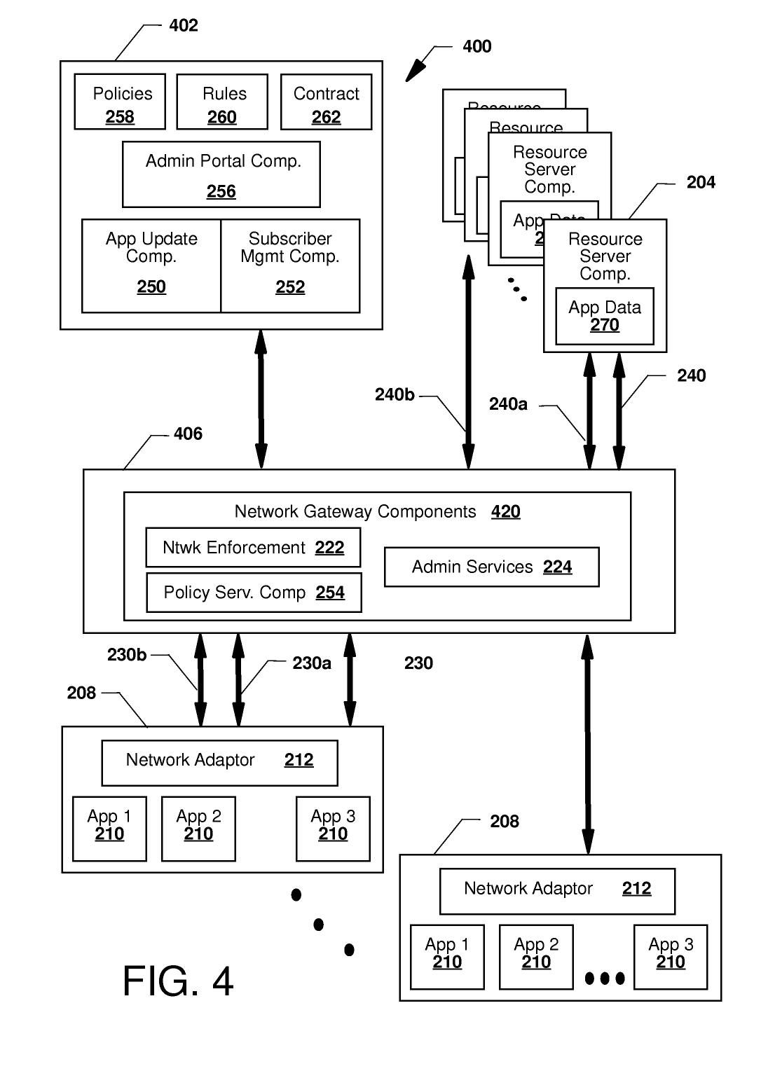

FIGS. 3 and 4 illustrate two additional exemplary implementations for the functional components for implementing other embodiments of the system illustrated in FIG. 1. Like reference numbers remain the same throughout FIGS. 2-4. In FIG. 3, the network enforcement component and policy services component 326 may be combined into a single entity, logical and physical, residing in a network gateway components 320 residing in the network operator component 306.

In FIG. 4, the network enforcement component 222 and the policy service component 254 may be separate logical functions but reside in the same physical location within the network operator component 406. As one skilled in the art will appreciate, additional permutations and combinations of components may be implemented without departing from the scope of the claimed invention. For example, the access server may include a network gateway in addition to or replacement of the network operator's gateway. In this scenario, the access server may act as a network operator proxing all traffic between device component 208 and resource server component 204. The network gateway component may also be present within corporate network environments. A corporate network gateway proxies data between computing devices residing within the corporate network and those residing outside the corporate network. In the case of a corporate network gateway, the access server component 202 or subsets of the access server component 202 may communicate directly with the network enforcement component 222 within the corporate network. In another variation, the access server components may be included in the network operator component, along with the network gateway components.

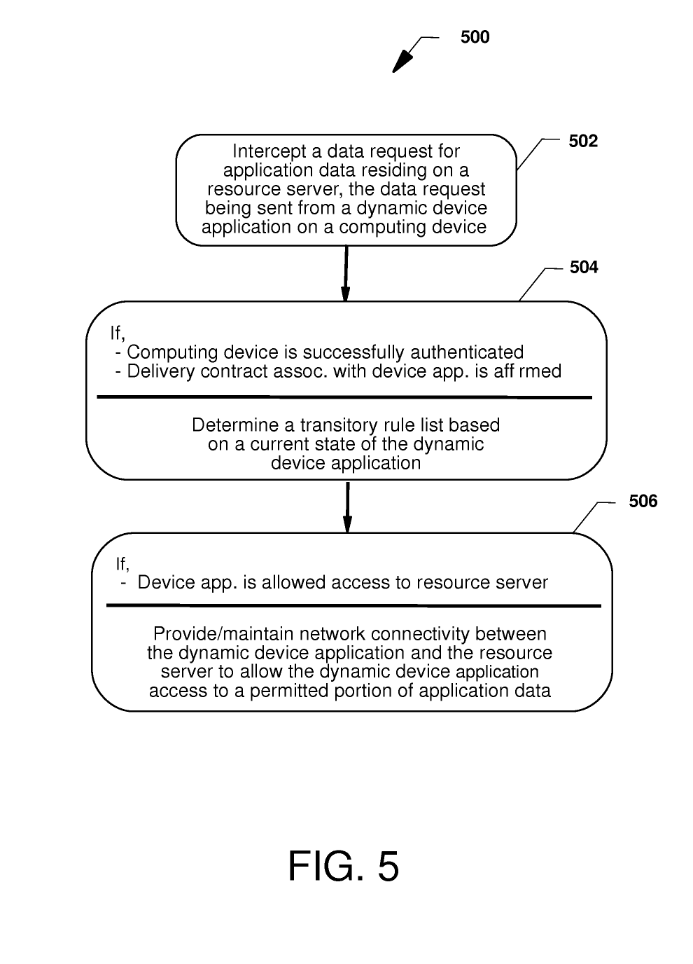

FIG. 5 is a flow diagram illustrating a process 500 for enabling network connectivity between a dynamic application and a remote resource server where the network connectivity is coupled to application data on the remote resource server as requested from a dynamic application residing on a device that is suitable for use in the functional components illustrated in FIG. 2. The dynamic application may execute in an application container, a browser, or some other mechanism that renders the experience of the application for the user. The dynamic application may be associated with a provider which provides a means for requests from the dynamic application to be intercepted by the access server in accordance with present disclosure. In another variation, a data access contract may be utilized in conjunction with the present system to provide limited access to resources if needed. At block 502, a data request for application data on a resource server is intercepted. The data request is generated as a user interacts with the dynamic application by selecting links to external servers to access the requested resources, such as application data.

Before proceeding further, an overview of the concept of static and dynamic applications is provided. Applications have states, which include internal state and external state transitions. The internal state transitions represent transitions to states that occur in response to end-user responses, such as an end-user response to an application query. For many applications, the internal state space may be bounded. However, even if the internal state space may be bounded, external states representing transitions to states that occur independently of a user's response may occur. Examples of these transitions include a flux of data requests handled by a load balancer managing the assignment of resource servers for a particular application data request. Applications that have a bounded internal state are referred to as static applications.

In other applications (hereinafter referred to as dynamic applications), the internal state space may be unbounded, such as when the dynamic application has non-deterministic sources of data located on resource servers not previously associated with the dynamic device application. Examples of dynamic applications having non-deterministic sources of data include search, communications, social apps, and the like. For example, in social networking applications, external resource links may be constantly added. The present system is directed at enabling network connectivity between a dynamic application and a remote resource server where the network connectivity is coupled to application data on the remote resource server as requested from a dynamic application residing on a device.

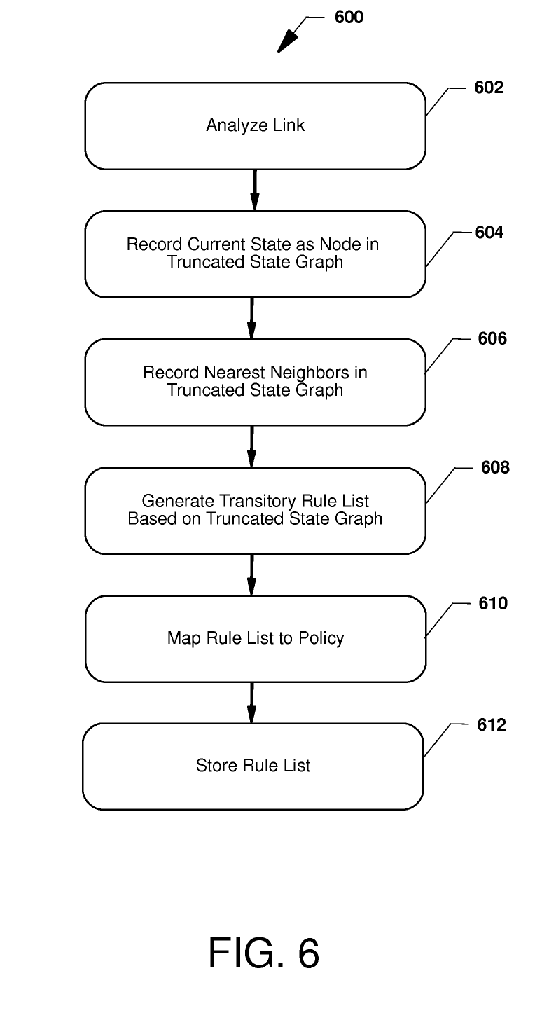

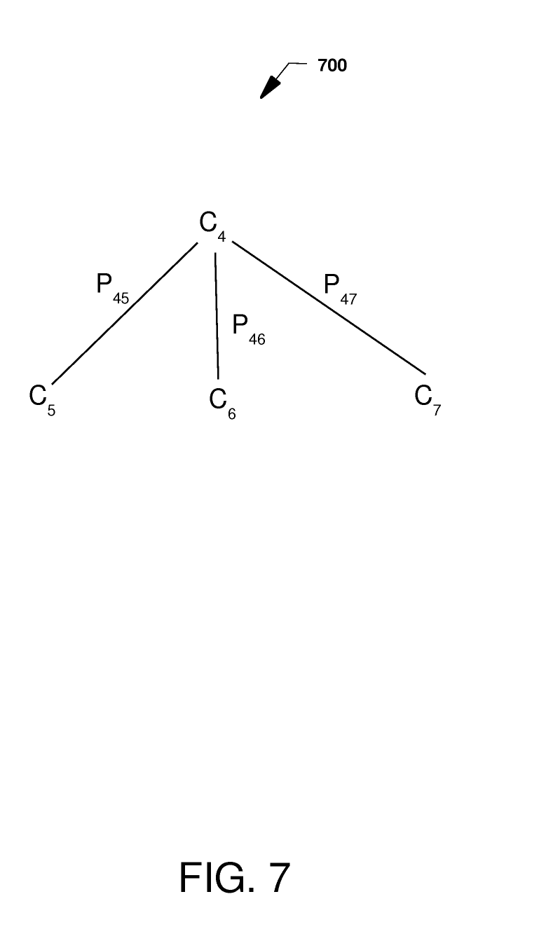

At block 504, if the computing device is successfully authenticated and the delivery contract associated with the dynamic device application and the computing device is affirmed, a stateful transitory rule list is generated based on a current state of the device application associated with the data request. In overview, the transitory rule list exists for a temporary time while the dynamic device application is in its current state and is based on the enforcement of an access policy given the current state. Various embodiments for generating a stateful rule list for a dynamic application may be implemented. One illustrative embodiment is described below in conjunction with FIGS. 6-7 in which processing is performed realtime as the dynamic device application transitions between states.

At block 506, if the dynamic device application is allowed access to the resource server and the application data based on the transitory rule list, network connectivity between the dynamic device application and the resource server is provided and/or maintained to allow the dynamic device application access to the application data. The computing device is then limited to application data explicitly permitted for the computing device. Once the application data is delivered to the computing device, the device application that requested the remote application data can process the application data. Thus, the network connectivity can be selectively bound to an application, a subset of the application data requests, or a multiplicity of applications' data. In addition, a content provider may permit only a subset of its application data to be available to the dynamic application. By allowing this fine-grain coupling of network connectivity to permitted application data, the content provider may easily implement a data access contract based access to its vast application data knowing that only the permitted subset will be accessible to an associated dynamic application. This fine-grain coupling is achieved by generating a transitory rule list upon receiving each request for application data from the dynamic application. As will be described below, in conjunction with FIG. 6, the transitory rule list is based on a policy and a current state of the dynamic application, which influence the rules within the transitory rule list. Because the transitory rule list is generated upon each request for application data, the rules within the transitory rule list may be granular to limit device application access based on individual application data requests.

FIG. 6 is a flow diagram for generating a transitory stateful rule list (hereinafter referred to as a transitory rule list) suitable for use in process 500 illustrated in FIG. 5. In overview, whether or not the selected link has permission to access an external resource associated with the selected link is determined by obtaining the nearest-neighbor states to which the current state can transition. At the time of selecting the link, the dynamic application is in a current state. Therefore, the nearest-neighbor states represent a list of possible transitional states. The list of possible transitional states is determined by reviewing the policy as it applies to the current state. A truncated state graph is used, which represents the current state of the dynamic application and the next possible states (i.e., nearest neighbor states). Therefore, each time the user selects a link, a truncated state graph is dynamically generated and a transitory rule list is created based on the truncated state graph. If the selected resource associated with the link is allowed by the transitory rule list, the dynamic application transitions to the selected link, thereby transitioning to a new current state.

As one skilled in the art will appreciate, various embodiments for the truncated state graph may be implemented without departing from the scope of the claimed invention. Process 600 generates the truncated state graph pertaining to the current state and any possible next states which are allowed by the policy given the current state. By generating a truncated state graph upon each selection of a new link in the dynamic application, the policies associated with the dynamic application may be enforced. Thus, process 600 is performed dynamically in real time by assessing the requested transition against a transitory rule list based on the specific policy that is being enforced and the truncated state graph for the current state.

At block 602, the selected link generated by the user's interaction with the dynamic application is analyzed. As illustrated in FIG. 2, for the current embodiment, gateway network components intercept the request and allows the access server component to dynamically generate a state graph and a stateful rule list, which is provided to the network enforcement component in order to determine whether the policy permits transitioning from the current state to a new state associated with the selected link. For this embodiment, the state graph is a truncated state graph and the stateful rule list is a transitory rule list. Thus, the analysis is based on the access policy relative to the specific user configuration of the dynamic application and on the current state of the dynamic application.

At block 604, the current state is recorded as a node in the truncated state graph. One will appreciate that the current state may have already been recorded as one of the possible states from a previous dynamic generation of a prior truncated state graph. While there are multiple variations as to how the truncated state graph is populated, any number of techniques for populating the truncated state graph is envisioned. For example, in another embodiment, process 600 may update and store information regarding the current state and each possible next state and maintain this information in the truncated state graph. In other embodiments, the truncated state graph may be created new for each selected link.

At block 606, the nearest neighbors are recorded in the truncated state graph. The nearest neighbors are determined by applying the policy to the current state. The nearest neighbors represents a list of possible transitional states. Each possible transitional state (i.e., nearest neighbor) is recorded as a node in the truncated state graph. In addition, a transition for each of the nearest neighbors is recorded in the truncated state graph. The transition will be recorded to indicate the action need to change from the current state to the corresponding nearest neighbor states. The transition may indicate that the transition from the current state to the nearest neighbor state is allowed or is denied based on the specific access policy and the current state of the application. Interestingly, process 600 enforces the specific policy and may determine to allow access to a specific resource server if the dynamic application is in one state, but may deny access to the same resource server if the dynamic application is in a different state.

Process 600 allows content providers the ability to selectively allow access to categories of their content based on the state of the application when it requests the access. This dynamic enforcement of access policies provides autonomous enforcement of the content provider's specified access policies with little or no overhead expense by the content provider for managing the enforcement. As discussed above, the truncated state graph includes the current state and each of the next possible states from which the application's current state can potentially transition. As one skilled in the art will appreciate, the current state may be any state of the application, including the initial state. Therefore, each time the user selects a link, a dynamically truncated state graph is generated or updated in order to determine whether the dynamic application has permission to traverse to the selected link, thereby providing rule coherency for dynamic applications as the user interacts with the dynamic application and as the dynamic application dynamically undergoes changes, such as additions of new links and the like.

At block 608, a transitory rule list is generated based on the truncated state graph. In this embodiment, the transitory rule list may be generated after each nearest neighbor is added to the truncated state graph, after all the nearest neighbors have been added, or any time in between. Thus, the transitory rule list that is generated is based on the current dynamic state of the dynamic application.

At block 610, the transitory rule list may be optionally mapped to the associated policy and stored for off-line statistical analysis at block 612. One will appreciate that there may be several policies applicable to the application and process 600 is performed for each applicable policy in order to determine if the selected link is allowed or not. The transitory rule list is then provided to the network enforcement component in the network gateway to allow the network enforcement component to either grant permission to the application to transition to the selected link or deny permission. As illustrated in FIG. 2, the transitory rule list may be output to the network enforcement component in the network gateway so that the network enforcement component can determine which data exchanges to permit between the dynamic device application and the resource servers that are on disparate networks.

FIG. 7 is an exemplary representation of a dynamically defined truncated state graph that is suitable to generate a transitory rule list in accordance with the process illustrated in FIG. 6. Truncated state graph 700 depicts an application (i.e., Application C) having a current state C₄ and three nearest neighbor states C₅ C₆ C₇, which as described above represent possible transitional states. A transitory rule list is generated from truncated state graph 700. For the dynamic application depicted in truncated state graph 700, the transitory rule list would include a rule to transition to each of the possible transitional states. Then, if the requested link is associated with one of these possible states, the dynamic application will be granted access to the resource server associated with the selected link. The truncated state graph 900 may be stored in the access server as a table, a database, or other format. In addition, optionally, the transitory rule list may be stored in the access server as a table, a database, or other format. While FIG. 7 illustrates the truncated state graph having three nearest neighbors, one will appreciate that that the number of nearest neighbors is variable and depends on the policy and the current state of the application.

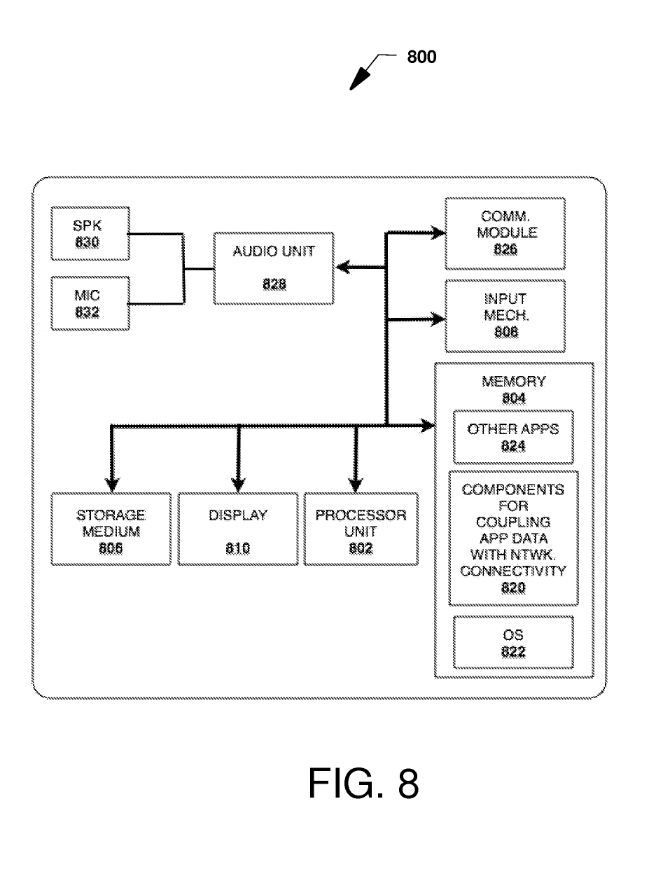

FIG. 8 is a functional block diagram representing a computing device suitable for use in implementations for dynamically provisioning a subset of the data on a requested resource server to be accessible to an individual dynamic device application that is coupled to an associated individual network connection. For example, access server shown in FIG. 2 may be a computing device such as shown in FIG. 8. The computing device 800 includes a processor unit 802, a memory 804, a storage medium 806, an input mechanism 808, and a display 810. The processor unit 802 advantageously includes a microprocessor or a special purpose processor such as a digital signal processor (DSP), but may in the alternative be any conventional form of processor, controller, microcontroller, state machine, or the like.

The processor unit 802 is coupled to the memory 804, which is advantageously implemented as RAM memory holding software instructions that are executed by the processor unit 802. These software instructions represent computer-readable instructions and computer executable instructions. In this embodiment, the software instructions stored in the memory 804 include components (i.e., computer-readable components) for coupling application data with network connectivity for a dynamic application 820, a runtime environment or operating system 822, and one or more other applications 824. The memory 804 may be on-board RAM, or the processor unit 802 and the memory 804 could collectively reside in an ASIC. In an alternate embodiment, the memory 804 could be composed of firmware or flash memory.

The storage medium 806 may be implemented as any nonvolatile memory, such as ROM memory, flash memory, or a magnetic disk drive, just to name a few. The storage medium 806 could also be implemented as a combination of those or other technologies, such as a magnetic disk drive with cache (RAM) memory, or the like. In this particular embodiment, the storage medium 806 is used to store data during periods when the computing device 800 is powered off or without power. The storage medium 806 could be used to store access policies, network rules, state graphs, and the like. It will be appreciated that the functional components may reside on a computer-readable medium and have computer-executable instructions for performing the acts and/or events of the various method of the claimed subject matter. The storage medium being on example of computer-readable medium.

The computing device 800 also includes a communications module 826 that enables bi-directional communication between the computing device 800 and one or more other computing devices. The communications module 826 may include components to enable RF or other wireless communications, such as a cellular telephone network, Bluetooth connection, wireless local area network, or perhaps a wireless wide area network. Alternatively, the communications module 826 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 828 may be a component of the computing device 800 that is configured to convert signals between analog and digital format. The audio unit 828 is used by the computing device 800 to output sound using a speaker 830 and to receive input signals from a microphone 832. The speaker 832 could also be used to announce incoming calls.

A display 810 is used to output data or information in a graphical form. The display could be any form of display technology, such as LCD, LED, OLED, or the like. The input mechanism 808 includes keypad-style input mechanism and other commonly known input mechanisms. Alternatively, the input mechanism 808 could be incorporated with the display 810, such as the case with a touch-sensitive display device. Other alternatives too numerous to mention are also possible.

As described above, the present disclosure describes a system for enabling network connectivity between a dynamic application and a remote resource server where the network connectivity is coupled to application data on the remote resource server as requested from a dynamic application residing on a device.

In addition to these advantageous, the system provides other advantageous over existing systems, such as eliminating the requirement for a device data connectivity contract and device provisioning to enable device application access to remote data. The system provides granular network access, such as at the application level, suite of application level, a specific subset of the data requested in a particular application, and the like. This unobtrusive implementation for users' devices along with the technique's ability to selectively couple access with application for dynamic applications provides a content provider the ability to bring to market a fast and efficient solution of controlling end user access to their various content classifications.

The content provider may restrict access to their content without a data access contract, but allow limited access to one or more specific items of content based on a user's application state. For example, a news agency may set a policy that users are unable to access a sports section without a data access contract but will allow access to one sports article if the current state of a user's application warrants access to the one sports article. However, if the user attempts to access said sports article directly from their site, the user will be denied access.

However, if specified by policy from the sports content provider, the user clicks on a link to the sports article from a friend's post on a social networking application, the user would have access to read the sports article, but would not have access to other sports articles. Once the policy is determined by the content provider, the content provider does not need to communicate any changes about their resource servers, because the present technique dynamically maintains access to their resource servers based on the policy provided.

The present system also supports having an individual network connection between the individual dynamic device application and the content provider's resource servers so that data traffic between the individual device application and their resource server allows access to the permitted data. Thus, the individual device application is appropriately limited to permitted data and does not have unlimited access to other data on the content provider's resource server or other resource servers via the individual network connection. Thus, the present disclosure describes a system configured to enable network connectivity between a dynamic application and a remote resource server where the network connectivity is coupled to application data on the remote resource server as requested from a dynamic application residing on a device. The system is configured to allow fine-grain coupling of network connectivity whereby permitted subsets of the application data are provisioned for access by the dynamic application. The network connectivity may be selectively coupled to a suite of applications, a specific application, a specific subset of the application data, or the like. The selectively coupling of the network connection being based on at least one access rule in the transitory rule list.

While the foregoing written description of the invention enables one of ordinary skill to make and use a system for coupling application data with network connectivity for dynamic application as described above, those of ordinary skill will understand and appreciate the existence of variations, combinations, and equivalents of the described embodiments, methods, and examples herein. Thus, the invention as claimed should therefore not be limited by the above described embodiments, methods, and examples, but by all embodiments and methods within the scope and spirit of the claimed invention.

The claimed invention is:

1. An access server for coupling application data with network connectivity, the access server comprising a memory for storing computer-readable instructions and a processor programmed to execute the computer-readable instructions, wherein when the computer-readable instructions are executed, the access server is programmed to:
determine a transitory rule list based on a current state of a dynamic device application, the transitory rule list identifying a plurality of resource servers accessible to the dynamic device application given the current state, wherein the current state is associated with a request for application data on a remote resource; and
enable network connectivity between the dynamic device application and the resource server if the transitory rule list allows the dynamic device application to access the application data, wherein the network connectivity is selectively coupled based on at least one access rule in the transitory rule list.

2. The access server of claim 1, wherein the network connectivity is selectively coupled to a suite of applications related to the dynamic device application.

3. The access server of claim 1, wherein the network connectivity is selectively coupled to a subset of the application data.

4. The access server of claim 3, wherein the network connectivity being specific to the dynamic device application and independent of another network connectivity between another dynamic device application and the resource server.

5. The access server of claim 1, wherein the subset of the application data varies based on the current state of the dynamic device application.

6. The access server of claim 1, wherein enabling network connectivity is further based on a delivery contract associated with the dynamic device application.

7. A computer-implemented method for coupling application data with network connectivity, comprising:
monitoring a request from a dynamic device application residing on a computing device, the request being associated with a subset of application data on a remote resource;
determining a transitory rule list based on a current state of the dynamic device application associated with the request, the rule list identifying a plurality of resource servers accessible to the dynamic device application given the current state;
allowing the dynamic device application access to the subset of application data based on the transitory rule list; and
providing network connectivity between the dynamic device application and the resource server wherein the network connectivity is specific to the dynamic device application.

8. The computer-implemented method of claim 7, wherein certain selectable links within the dynamic device application are provisioned for access to the subset of application data.

9. The computer-implemented method of claim 7, wherein determining the transitory rule list is further based on a policy allowing a suite of applications related to the dynamic device application access to the subset of the application data.

10. The computer-implemented method of claim 7, wherein the current state of the dynamic device application is determined based on the request.

11. The computer-implemented method of claim 7, wherein the current state of the dynamic device application is determined based on a sequence of prior requests by the dynamic device application.

12. The computer-implemented method of claim 7, wherein the transitory rule list is generated using a truncated state graph where the current state is a node and each of a plurality of possible states to which the current state can transition are additional nodes.

13. A system for coupling application data with network connectivity, said system comprising:
a memory storing computer-readable components;
a processor programmed to execute the computer-readable components; the computer-readable components comprising:
a gateway component configured to monitor a request from a dynamic device application residing on a computing device, the request being associated with access to a remote resource having application data;
an application update component configured to determine a transitory rule list based on a current state of the dynamic device application associated with the request, the transitory rule list identifying a plurality of resource servers accessible to the dynamic device application given the current state;
an enforcement component configured to enable the dynamic device application access to the application data residing on the resource server based on the transitory rule list; and
an administration component configured to provide network connectivity between the dynamic device application and the resource server, wherein the network connectivity is selectively coupled based on at least one access rule in the transitory rule list.

14. The system of claim 13, wherein the network connectivity is selectively coupled to a suite of applications related to the dynamic device application.

15. The system of claim 13, wherein the network connectivity is selectively coupled to a subset of the application data.

16. The system of claim 15, wherein the subset of the application data varies based on the current state of the dynamic device application.

17. The system of claim 13, wherein the network connectivity is specific to the dynamic device application and independent of another network connectivity between another dynamic device application and the resource server.

18. The system of claim 13, wherein the administration component is further configured to provide the network connectivity upon authenticating the computing device associated with the request and affirming a delivery contract associated with the device application.

19. The system of claim 18, wherein network connectivity between the dynamic device application and the resource server is provided in accordance with the delivery contract.

20. The system of claim 13, wherein the enforcement component is configured to provide a fine-grain coupling of the access.
